(19) United States
(12) Patent Application Publication
(10) Pub. No.: US 2016/0033707 A1
(43) Pub. Date: Feb. 4, 2016

(54) LIGHT GUIDE PLATE, METHOD FOR FABRICATING THE SAME, BACKLIGHT UNIT INCLUDING THE SAME, AND LIQUID CRYSTAL DISPLAY INCLUDING THE SAME

(71) Applicant: SAMSUNG SDI CO., LTD., Yongin-si (KR)

(72) Inventors: Jeong Ho Lee, Uiwang-si (KR); Young Oh, Uiwang-si (KR); Young Hyun Ju, Uiwang-si (KR); Seung Man Choi, Uiwang-si (KR)

(21) Appl. No.: 14/814,476

(22) Filed: Jul. 30, 2015

(30) Foreign Application Priority Data
Jul. 31, 2014 (KR) 10-2014-0098603
Jul. 31, 2014 (KR) 10-2014-0098604

(51) Int. Cl. F21V 8/00; G02F 1/1335

(52) U.S. Cl. CPC G02B 6/0016; G02B 6/0043; G02B 6/0025; G02F 1/133528

(57) ABSTRACT

Embodiments of the present invention provide a light guide plate, a method for fabricating the same, a backlight unit including the same, and a liquid crystal display including the same. The light guide plate may include a base layer, a first coating layer formed on one surface of the base layer and including a first optical pattern having a curved surface at a top portion thereof, and a second coating layer formed on the other surface of the base layer and including a second optical pattern. The first optical pattern has an aspect ratio of about 0.10 to about 0.50 and a radius of curvature of the curved surface of about 10 μm to about 35 μm, and the second optical pattern has an aspect ratio of about 0.01 to about 0.07.

### CROSS-REFERENCE TO RELATED APPLICATION

This application claims priority to and the benefit of Korean Patent Application 10-2014-0098603, filed Jul. 31, 2014, and Korean Patent Application 10-2014-0098604, filed Jul. 31, 2014, the entire contents of both of which are incorporated herein by reference.

### BACKGROUND

1. Technical Field

The present invention relates to a light guide plate, a method for fabricating the same, a backlight unit including the same, and a liquid crystal display including the same.

2. Description of the Related Art

A liquid crystal display may include a light source, a light guide plate (LGP) beside or above the light source, a light collecting sheet above the light guide plate for collecting light exiting the light guide plate, and a reflective sheet below the light guide plate for reflecting light emitted from the light source to redirect the light to the light guide plate. A light collecting sheet formed with inverted prisms may be used in the liquid crystal display. The light collecting sheet formed with inverted prisms includes a base layer, and prisms formed on a lower surface of the base layer, where the lower surface of the base layer forms a light entering surface. The light collecting sheet formed with the inverted prisms allows light exiting the light guide plate to enter one inclined surface of each of the inverted prisms, and then be reflected by another inclined surface adjoining the one inclined surface. Thus, the light collecting sheet formed with the inverted prisms exhibits good light collection efficiency.

The light guide plate can guide light emitted from the light source to travel to the light collecting sheet. In order to improve light collection efficiency and brightness, the structure of the upper surface and/or the lower surface of the light guide plate should be controlled. Particularly, in a liquid crystal display using a light collecting sheet formed with inverted prisms, the light guide plate should have a proper light-exiting angle and high light collection efficiency.

### SUMMARY

In accordance with embodiments of the present invention, a light guide plate may include: a base layer; a first coating layer formed on one surface of the base layer and including a first optical pattern having a curved surface at a top portion thereof; and a second coating layer formed on the other surface of the base layer and including a second optical pattern. The first optical pattern may have an aspect ratio of about 0.10 to about 0.50, and a radius of curvature of the curved surface of about 10 μm to about 35 μm. The second optical pattern may have an aspect ratio of about 0.01 to about 0.07.

In accordance with embodiments of the present invention, a method for fabricating a light guide plate may include: forming a first coating layer including a first optical pattern on one surface of a base layer; and forming a second coating layer including a second optical pattern on the other surface of the base layer. The first optical pattern may have at least one curved surface at a top portion thereof, and have an aspect ratio of about 0.10 to about 0.50 and a radius of curvature of the curved surface of about 10 μm to about 35 μm. The second optical pattern may have an aspect ratio of about 0.01 to about 0.07.

In accordance with embodiments of the present invention, a backlight unit may include: a light guide plate; and a light collecting sheet above the light guide plate and formed with an inverted prism. The light guide plate may include the light guide plate according to embodiments of the present invention.

In accordance with embodiments of the present invention, a liquid crystal display may include the backlight unit as set forth herein.

### BRIEF DESCRIPTION OF THE DRAWINGS

FIG. 1 is a schematic perspective view of a light guide plate according to embodiments of the present invention.

FIG. 2 is a cross-sectional view of the light guide plate of FIG. 1 taken along X-X′.

FIG. 3 is a cross-sectional view of the light guide plate of FIG. 1 taken along Y-Y′.

FIG. 4 is a schematic perspective view of a light guide plate according to embodiments of the present invention.

FIG. 5 is a cross-sectional view of the light guide plate of FIG. 4 taken along Y-Y′.

FIG. 6 is a conceptual view of the arrangement of micro-lens patterns in the light guide of FIG. 4.

FIG. 7 is a schematic perspective view of a light guide plate according to embodiments of the present invention.

FIG. 8 is a schematic cross-sectional view of a backlight unit according to embodiments of the present invention.

FIG. 9 is a schematic cross-sectional view of a light collecting sheet formed with an inverted prism in a backlight unit according to embodiments of the present invention.

FIG. 10 is a schematic cross-sectional view of a liquid crystal display according to embodiments of the present invention.

FIG. 11 is a mimetic diagram of a light guide plate sample for measurement of brightness.

FIG. 12 is a conceptual view of a light guide plate showing a light-exiting angle.

### DETAILED DESCRIPTION

Embodiments of the present invention will be described with reference to the accompanying drawings. It should be understood that the present invention may be embodied in different ways and is not limited to the described embodiments. In the drawings, portions irrelevant to the description are omitted for clarity. Like components are denoted by like reference numerals throughout the specification.

As used herein, terms such as “upper” and “lower” are defined with reference to the accompanying drawings. Thus, it is understood that the term “upper side” can be used interchangeably with the term “lower side”. In addition, it is understood that when an element such as a layer, film, region or substrate is referred to as being placed “above” or “on” another element, it can be placed directly on the other element, or intervening layer(s) may also be present. On the contrary, when such an element is referred to as being placed “directly above” or “directly on” another element, intervening layer(s) are not present.

As used herein, the term “aspect ratio” refers to a ratio of the maximum height of an optical pattern to the maximum width of the optical pattern (i.e., maximum height of the optical pattern/maximum width of the optical pattern).

As used herein, the term “radius of curvature,” in the case of an optical pattern having a curved surface at a top portion thereof, refers to the radius of an imaginary circle including the curved surface, and in the case of a prism pattern, refers to the radius of an imaginary circle including a curved surface tangential to both one inclined surface of the prism and the other inclined surface of the prism that meets (or adjoins) the one inclined surface.

As used herein, the term “fill factor” refers to the ratio of the total area of the convex portions of the micro-lens patterns to the total area of the coating layer formed with the micro-lens patterns (i.e., total area of the convex portions of the micro-lens patterns/total area of the coating layer formed with the micro-lens patterns).

In the drawings, the terms “x-axis”, “y-axis”, and “z-axis” refer to the transverse direction, the longitudinal direction, and the vertical direction of the first optical pattern, respectively, and refer to the longitudinal direction, the transverse direction, and the vertical direction of the second optical pattern, respectively. The “x-axis”, “y-axis”, and “z-axis” lie at right angles to one another.

As used herein, the term “(meth)acrylic” refers to “acrylic” and/or “methacrylic”.

As used herein, the term “top portion” refers to a portion located uppermost with respect to a lowermost portion of an optical structure.

As used herein, the term “inverted prism” refers to a prism formed on a light-entering surface.

As described herein, a light guide plate (LGP) may include a light guide film (LGF) having a thickness of about 600 μm or less.

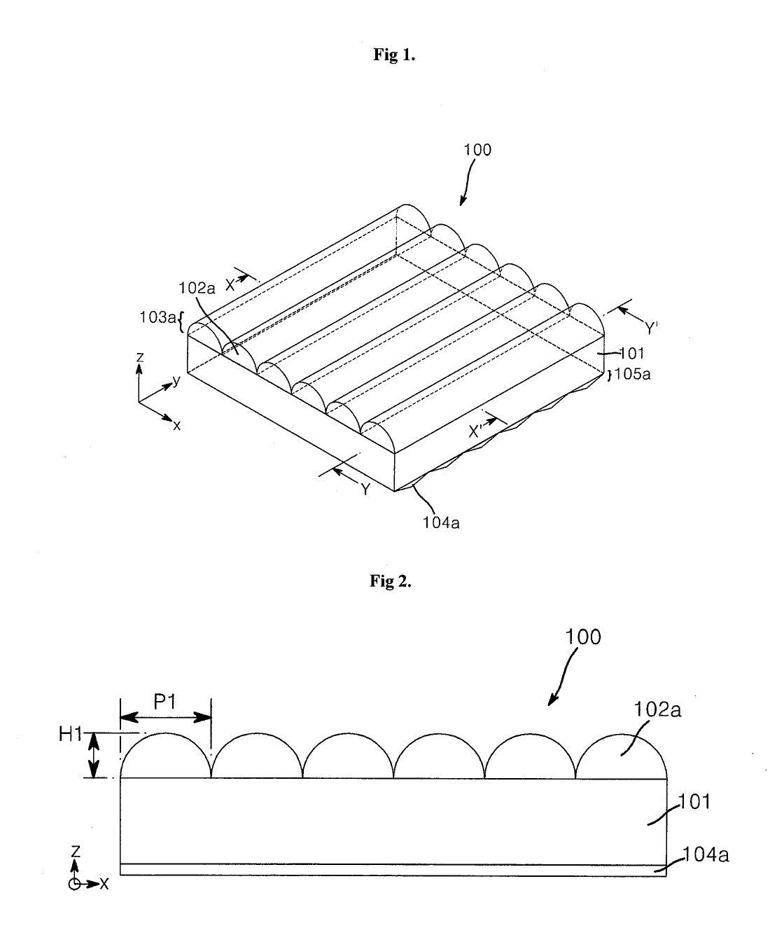

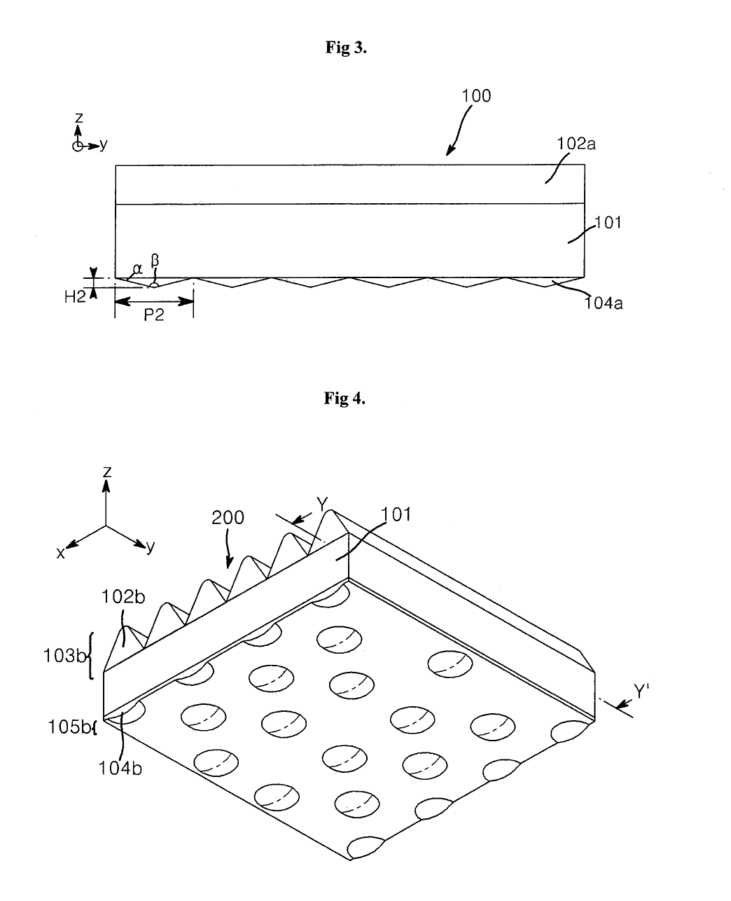

Hereinafter, a light guide plate according to embodiments of the present invention is described with reference to FIGS. 1 to 3. FIG. 1 is a schematic perspective view of a light guide plate according to embodiments of the invention. FIG. 2 is a cross-sectional view of the light guide plate of FIG. 1 taken along X-X′. FIG. 3 is a cross-sectional view of the light guide plate of FIG. 1 taken along Y-Y′.

Referring to FIG. 1, the light guide plate 100 according to embodiments of the invention may include a base layer 101, a first coating layer 103a including one or more first optical patterns 102a, and a second coating layer 105a including one or more second optical patterns 104a.

The base layer 101 may support the first coating layer 103a and the second coating layer 105a. The base layer 101 may guide light emitted from a light source to exit toward a light collecting sheet formed with an inverted prism (not shown in FIG. 1), and the like.

An upper surface, lower surface, and lateral surface of the base layer 101 may be a light exiting surface, a light incident surface for receiving light emitted from the second coating layer 105a, and a light incident surface for receiving light emitted from the light source (not shown in FIG. 1), respectively.

The base layer 101 may have a thickness of about 200 μm to about 700 μm, for example, about 300 μm to about 500 μm. Within either of these ranges, the base layer 101 is suitable for use in an optical display.

The base layer 101 may have a refractive index of about 1.50 or greater, for example, about 1.50 to about 1.60. Within either of these ranges, the base layer can increase the light-exiting rate, thereby improving optical efficiency.

The base layer 101 may be formed of a resin having a refractive index of about 1.50 or greater, for example, about 1.50 to about 1.60. For example, the base layer 101 may be formed of at least one of a polycarbonate resin and a polymethyl (meth)acrylate resin. In some embodiments, for example, a polycarbonate resin may enable decreased thickness of the base layer.

The first coating layer 103a is formed on one surface of the base layer 101. The first coating layer 103a prevents (or reduces the amount of) light scattering, thereby increasing brightness and allowing light exiting the base layer 101 to pass therethrough. The first coating layer 103a may have a thickness of about 10 μm to about 40 μm. Within this range, the first coating layer is suitable for use in an optical display.

The first coating layer 103a may have a refractive index of about 1.50 to about 1.65. Within this range, the first coating layer enables an increased light-exiting rate, thereby improving optical efficiency.

The first coating layer 103a may be formed of a resin for the first coating layer having a refractive index of about 1.50 to about 1.65. The resin for the first coating layer may include a UV curable resin. Nonlimiting examples of the UV curable resin may include (meth)acrylic resins, polycarbonate resins, styrene resins, olefin resins, polyester resins, and mixtures thereof.

The first coating layer 103a may include a first optical pattern 102a.

The first optical pattern 102a is formed on one surface of the base layer 101. The first optical pattern 102a may include an optical pattern having at least one curved surface at a top portion thereof. FIG. 1 shows a light guide plate formed with a lenticular lens pattern as the first optical pattern 102a. However, the first optical pattern 102a is not limited thereto, and may be any pattern so long as the optical pattern has a curved surface at a top portion thereof. For example, the first optical pattern may include a prism pattern having a curved surface at a top portion thereof, a micro-lens pattern, an embossed pattern, or a combination thereof.

The first optical pattern 102a may have an aspect ratio of about 0.10 to about 0.50, and a radius of curvature of the curved surface of about 10 μm to about 35 μm. Within these ranges, the first optical pattern can serve to guide and diffuse incident light, and the viewing angle perpendicular to the first optical pattern can be narrowed, thereby improving luminous efficacy and brightness.

The first optical pattern 102a may have a width P1 of about 10 μm to about 50 μm, and a height H1 of about 1 μm to about 35 μm. Within these ranges, the first optical pattern can collect light in a lateral direction, thereby improving optical efficiency, enabling the first optical pattern to guide and diffuse incident light, and enabling the viewing angle perpendicular to the first optical pattern to be narrowed, thereby improving luminous efficacy and brightness.

Referring to FIG. 2, the first optical pattern 102a may have a semicircular cross-section. However, in some embodiments, the first optical pattern may have a modified semicircular cross-section, a semielliptical cross-section, or a modified semielliptical cross-section so long as the first optical pattern has an aspect ratio of about 0.10 to about 0.50, and the curved surface has a radius of curvature of about 10 μm to about 35 μm.

The first optical pattern 102a may have a different refractive index from the first coating layer 103a. However, when the first coating layer 103a has the same refractive index as the first optical pattern 102a, it is possible to improve processability of the light guide plate.

The second coating layer 105a is formed on the other surface of the base layer 101. The second coating layer 105a can prevent some of the light passing through the base layer 101 from scattering, and can reflect light emitted from the light source to exit therethrough.

The second coating layer 105a may have a thickness of about 0.6 μm to about 5 μm. Within this range, the second coating layer is suitable for use in a liquid crystal display.

The second coating layer 105a may have a refractive index of about 1.50 to about 1.65. Within this range, the second coating layer can enable an increased light-exiting rate, thereby improving optical efficiency.

The second coating layer 105a may be formed of a resin for the second coating layer having a refractive index of about 1.50 to about 1.65. The resin for the second coating layer may include a UV curable resin. Nonlimiting examples of the UV curable resin may include (meth)acrylic resins, polycarbonate resins, styrene resins, olefin resins, polyester resins, and mixtures thereof. The second coating layer 105a may be formed of the same resin or a different resin than that of the first coating layer 103a.

The second coating layer 105a may include a second optical pattern 104a.

The second optical pattern 104a is formed on the other surface of the base layer 101. The second optical pattern 104a may have an aspect ratio of about 0.01 to about 0.07. Within this range, the second optical pattern can improve the collection efficiency of light exiting the light guide plate. In some embodiments, for example, the second optical pattern 104a may have an aspect ratio of about 0.01 to about 0.06.

FIG. 1 shows the light guide plate formed with a prism pattern having a triangular cross-section as the second optical pattern 104a. However, the second optical pattern 104a is not limited to this shape, and can take any shape so long as the second optical pattern has an aspect ratio of about 0.01 to about 0.07. For example, the second optical pattern may include a micro-lens pattern, a prism pattern having a polygonal cross-section (i.e., an n-polygonal shape, where n is an integer from 4 to 10), an embossed pattern, a lenticular lens pattern, or the like.

Referring to FIG. 3, the second optical pattern 104a may have a width P2 of about 50 μm to about 150 μm, and a height H2 of about 0.5 μm to about 5.0 μm. Within these ranges, the second optical pattern can enable improvements in the light collection efficiency, thereby improving optical efficiency. For example, the second optical pattern 104a may have a lower height than conventional light guide plates in order to reduce the aspect ratio, and can thus improve the light collection efficiency, which improves the optical efficiency even when a light collecting sheet formed with an inverted prism is placed above the light guide plate.

Each tilt angle of the second optical pattern 104a (adjacent to the light source placed beside the base layer 101) is smaller than that of conventional light guide plates, enabling light to be collected without scattering even when the light collecting sheet formed with the inverted prism is used. For example, in some embodiments, the second optical pattern 104 may have a tilt angle (α) of about 1.2° to about 3.5°. In addition, the second optical pattern 104a may have an apex angle (β) of about 173° to about 177°. Within these ranges, the second optical pattern enables improvements in optical efficiency. As used herein, the term “apex angle” refers to the angle between one inclined surface of the second optical pattern and another inclined surface meeting (or adjoining) the one inclined surface.

Although the second optical pattern 104a may have a different refractive index than the second coating layer 105a, in some embodiments, the second optical pattern has the same refractive index as the second coating layer in order to improve processability.

The longitudinal direction of the second optical pattern 104a may form an angle in a predetermined (or desired) range, for example, about 85° to about 95°, with respect to the longitudinal direction of the first optical pattern 102a. Within this range, it is possible to prevent a pitch moiré phenomenon from occurring between the optical patterns while providing improved brightness. For example, referring to FIG. 1, assuming that the longitudinal directions of the first optical pattern 102a and the second optical pattern 104a are the y-axis and the x-axis, respectively, the x-axis and the y-axis lie at right angles to each other.

When the light collecting sheet formed with the inverted prism is placed above the light guide plate, the light collecting sheet allows light exiting the light guide plate to travel through one inclined surface of the inverted prism and then to travel through the other inclined surface of the inverted prism while undergoing total reflection, and can thus provide good light collection efficiency, thereby further increasing brightness. However, in a conventional light guide plate which is formed with a pattern having high height only on a lower surface thereof without having a pattern on an upper surface thereof, light can scatter without sufficiently entering the inverted prism, thereby causing deteriorations in brightness.

On the contrary, in the light guide plate 100 according to embodiment of the invention, the first optical pattern 102a may have an aspect ratio and a radius of curvature in specified ranges, and the second optical pattern 104a may have an aspect ratio in a specified range. Thus, the light guide plate 100 according to embodiments allows light entering the light guide plate to exit at a specific light-exiting angle, for example, about 60° to about 80°, or about 70° to about 75°, with respect to a surface of the base layer, and can thus increase brightness even when the light collecting sheet formed with the inverted prism is placed above. For example, based on an optical axis, the first optical pattern 102a collects light in the lateral direction (i.e, the x-axis direction in FIG. 1), and the second optical pattern 104a collects light in the vertical direction (i.e., the z-axis direction in FIG. 1) such that light exiting the light guide plate can exit without spreading vertically and/or laterally, thereby improving light collection efficiency to increase brightness. In addition, since the first optical pattern 102a has a greater aspect ratio than the second optical pattern 104a, light collection efficiency can be further improved. For example, a ratio of the aspect ratio of the first optical pattern to the aspect ratio of the second optical pattern (i.e., aspect ratio of the first optical pattern/aspect ratio of the second optical pattern) may be about 2 to about 50, for example, about 2 to about 30. Within these ranges, light collection efficiency can be improved. FIG. 12 is a conceptual view of the “light-exiting angle” as that term is used herein. Referring to FIG. 12, assuming the direction perpendicular to the light exiting surface of the light guide plate (i.e., L in FIG. 12) is 0°, the light-exiting angle refers to an angle (θ) defined between L and the light-exiting direction.

The light guide plate 100 according to embodiments of the invention may be fabricated, for example, by injection molding or extrusion. The light guide plate 100 according to embodiments of the invention may also be referred to as a light guide film (LGF).

Next, a light guide plate according to embodiments of the invention will be described with reference to FIG. 1.

The light guide plate according to embodiments of the invention may include a base layer 101, a first coating layer 103a including one or more first optical patterns 102a, and a second coating layer 105a including one or more second optical patterns 104a. Each of the first coating layer 103a and the second coating layer 105a may have a refractive index that is greater than or equal to that of the base layer. This light guide plate is substantially the same as the light guide plate discussed above except that each of the first coating layer and the second coating layer has a refractive index that is greater than or equal to that of the base layer.

Since the first coating layer 103a has a refractive index that is greater than or equal to that of the base layer 101, optical loss can be prevented or reduced. For example, in some embodiments, a ratio of the refractive index of the first coating layer 103a to the refractive index of the base layer 101 may be about 1 to about 1.1, for example, about 1 to about 1.04. Within these ranges, the light guide plate can exhibit an improved light-exiting rate and optical efficiency.

Since the second coating layer 105a has a refractive index that is greater than or equal to that of the base layer 101, it is possible to prevent (or reduce) deteriorations in optical efficiency due to the phenomenon of incident light being only reflected inside the light guide plate and thus being unable to exit the light guide plate. For example, in some embodiments, the ratio of the refractive index of the second coating layer 105a to the refractive index of the base layer 101 may be about 1 to about 1.1, for example, about 1 to about 1.04. Within these ranges, the light guide plate can exhibit an increased light-exiting rate and optical efficiency.

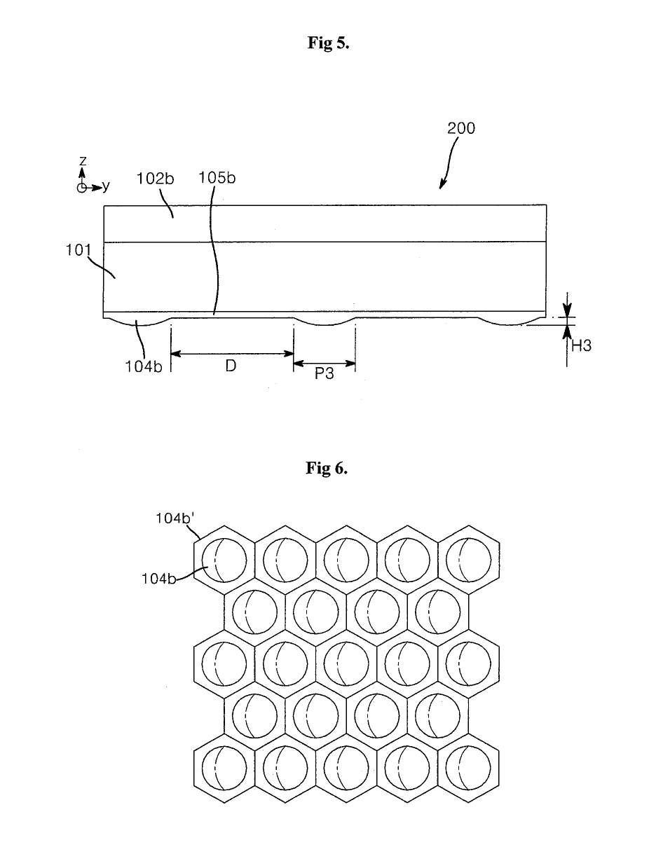

Next, a light guide plate according to embodiments of the invention will be described with reference to FIGS. 4 to 6. FIG. 4 is a perspective view of a light guide plate according to embodiments of the invention, FIG. 5 is a cross-sectional view of the light guide plate of FIG. 4 taken along Y-Y′, and FIG. 6 is a conceptual view showing the arrangement of micro-lens patterns 104b in FIG. 4.

Referring to FIG. 4, a light guide plate 200 according to embodiments may include a base layer 101, a first coating layer 103b formed on one surface of the base layer 101 and including a prism pattern 102b having a curved surface at a top portion thereof, and a second coating layer 105b formed on the other surface of the base layer 101 and including a micro-lens pattern 104b. The light guide plate 200 allows light exiting the light guide plate to exit at a specific exit angle, for example, at about 60° to about 80° without scattering (thereby increasing brightness) even when a light collecting sheet including an inverted prism is used.

This light guide plate is substantially the same as the light guide plate discussed above except that the prism pattern having a curved surface at the top portion thereof is formed as the first optical pattern (instead of a lenticular-lens pattern), and the micro-lens pattern is formed as the second optical pattern (instead of the prism pattern). Thus, the prism pattern having the curved surface at the top portion thereof and the micro-lens pattern are now described.

The prism pattern 102b having the curved surface at the top portion thereof may include a pattern obtained by transforming a prism pattern having a triangular cross-section such that the curved surface is formed at the top portion of the prism pattern.

As shown in FIG. 6, the micro-lens patterns 104b are arranged as hexagonal-type regularly arranged lenses rather than being randomly arranged, such that the micro-lens patterns 104b are equally spaced from one another. As used herein, the term “regularly arranged lenses” refers to a state in which virtual regular hexagons 104b′ surrounding the respective micro lens patterns are formed adjacent to one another, as shown in FIG. 6. Referring to FIG. 5, a distance D between the micro-lens patterns 104b may be about 1 μm to about 200 μm. Within this range, the light guide plate can achieve increased brightness.

The micro-lens pattern 104b may have any cross-sectional shape so long as the micro-lens pattern satisfies the aspect ratio described above. Referring to FIG. 5, the micro-lens pattern 104b may have a width P3 of about 10 μm to about 100 μm, and a height H3 of about 1 μm to about 5 μm. Within these ranges, the light guide plate can provide light collection effects when a light collecting sheet including an inverted prism is used.

Although FIG. 4 shows an embossed micro-lens pattern 104b, the light guide plate may also be formed with an engraved micro-lens pattern.

The second coating layer 105b having the micro-lens pattern 104b may have a fill factor of about 5% to about 90%, for example, about 10% to about 88%. Within these ranges, the second coating layer can improve optical uniformity and optical efficiency. Such a fill factor may be achieved by controlling the distance between the micro-lens patterns and the arrangement of the micro-lens patterns.

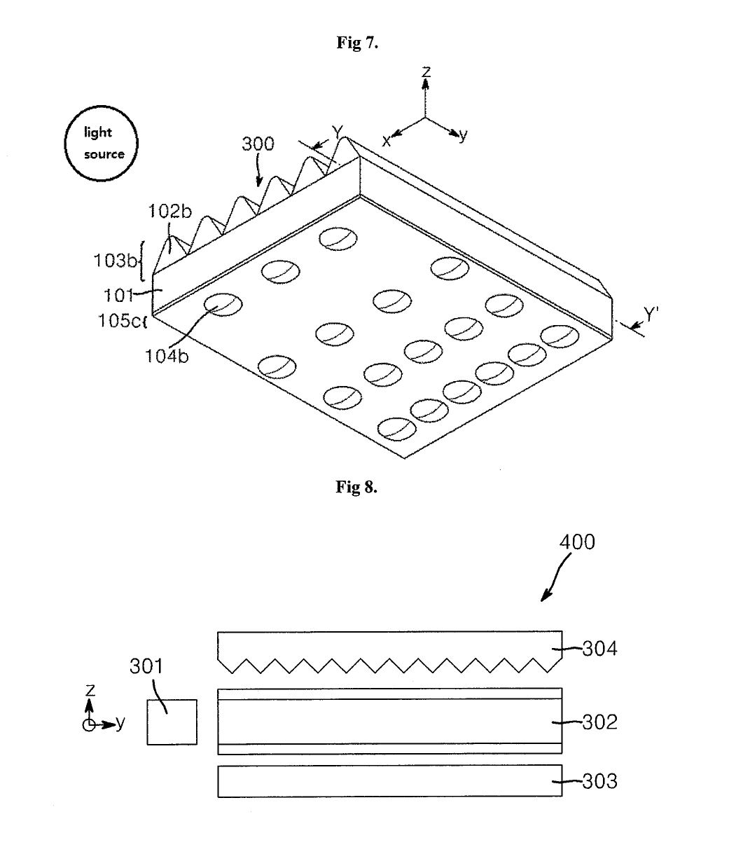

Next, a light guide plate according to embodiments of the present invention is described with reference to FIG. 7. FIG. 7 is a perspective view of a light guide plate according to embodiments of the present invention.

Referring to FIG. 7, a light guide plate 300 according to embodiments of the invention may include a base layer 101, a first coating layer 103b formed on one surface of the base layer 101 and including a prism pattern 102b having a curved surface at a top portion thereof, and a second coating layer 105c formed on the other surface of the base layer 101 and including a micro-lens pattern 104b. The distance between micro-lens patterns 104b decreases and the density of the micro lens patterns 104b increases as the distance between the micro lens patterns 104b and a light source increases. As a result, this light guide plate according to embodiments of the present invention can minimize optical loss while providing uniform (or improving) brightness.

This light guide plate is substantially the same as the light guide plate discussed above except that the distance between the micro-lens patterns decreases and the density of the micro lens patterns increases as the distance between the micro lens patterns and the light source increases.

Hereinafter, a method of fabricating a light guide plate according to embodiments of the invention is described. The light guide plates according to embodiments may be fabricated by imprinting using an engraving roll, which allows fabrication of a thin light guide film having a thickness of about 600 μm or less.

The method of fabricating a light guide plate according to embodiments of the invention may include forming a first coating layer including a first optical pattern on one surface of a base layer, and forming a second coating layer including a second optical pattern on the other surface of the base layer. The first optical pattern may be formed with at least one curved surface at a top portion thereof, and may have an aspect ratio of about 0.10 to about 0.50 and a radius of curvature of the curved surface of about 10 μm to about 35 μm. The second optical pattern may have an aspect ratio of about 0.01 to about 0.07.

The first optical pattern may be formed by coating a resin for the first coating layer onto an engraving roll with the first optical pattern engraved therein and bringing the engraving roll into contact with one surface of the base layer, followed by curing. The second optical pattern may be formed by coating a resin for the second coating layer onto an engraving roll with the second optical pattern engraved therein and bringing the engraving roll into contact with the other surface of the base layer, followed by curing. Curing may include, for example, UV curing. For example, curing may include irradiation at about 100 mJ to about 250 mJ. The first optical pattern and the second optical pattern may be formed in any order and may be formed sequentially or simultaneously.

Each of the first coating layer and the second coating layer may have a refractive index that is greater than or equal to that of the base layer.

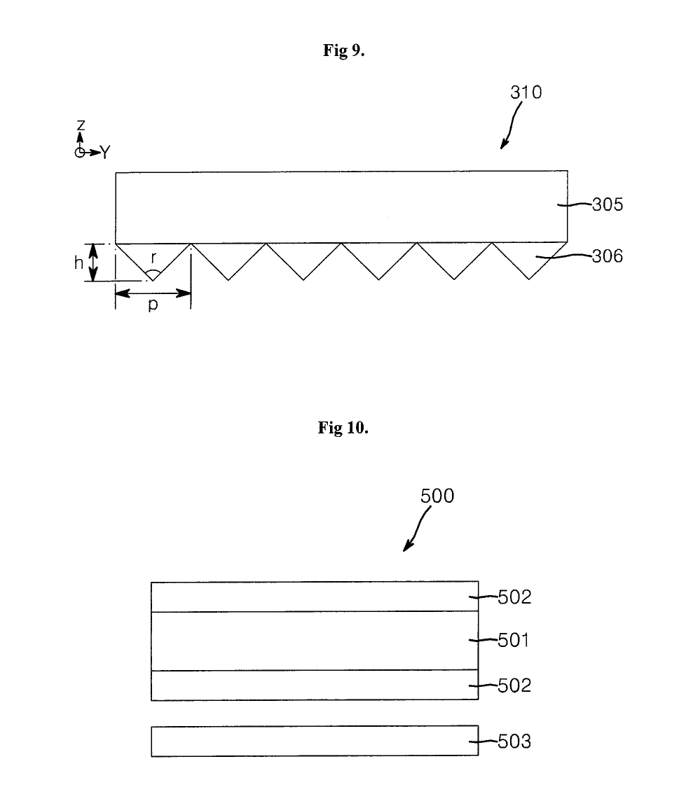

Hereinafter, a backlight unit according to embodiments of the present invention is described with reference to FIGS. 8 to 9. FIG. 8 is a cross-sectional view of a backlight unit according to embodiments of the present invention, and FIG. 9 is a cross-sectional view of a light collecting sheet formed with an inverted prism in the backlight unit according to embodiments of the present invention.

Referring to FIG. 8, a backlight unit 400 according to embodiments of the invention may include a light source 301, a light guide plate 302 for guiding light emitted from the light source 301, a reflective sheet 303 placed below the light guide plate 302, and a light collecting sheet 304 formed with inverted prisms placed above the light guide plate 302. The light guide plate 302 may include a light guide plate according to embodiments of the present invention.

The light source 301 generates light and may include any of various light sources, such as a linear or planar fluorescent lamp, CCFLs, or LEDs. A light source cover (not shown) may be formed outside the light source to protect the light source.

Although the location of the light source 301 is not particularly limited in the backlight unit, the backlight unit may be an edge-type backlight unit where the light source is placed beside the light guide plate 302.

The light guide plate 302 may serve to guide light emitted from the light source onto a prism sheet.

The reflective sheet 303 may serve to reflect light emitted from the light source, and redirect the light to the light guide plate, thereby improving optical efficiency.

The light collecting sheet 304 formed with the inverted prisms collects light exiting the light guide plate and supplies the light to an optical sheet. Referring to FIG. 9, the light collecting sheet 310 formed with the inverted prisms may include a base film 305 and an inverted prism pattern 306 formed on a lower surface of the base film 305. The inverted prism pattern 306 may have a width p of about 10 μm to about 30 μm, an apex angle γ of about 65° to about 70°, and a height h of about 7 μm to about 24 μm. Within these ranges, the inverted prism pattern can improve optical efficiency. As used herein, the term “apex angle” refers to the angle defined between one inclined surface of the inverted prism pattern and another inclined surface of the inverted prism pattern meeting (or adjoining) the one inclined surface.

Although the inverted prism pattern is shown as having a triangular cross-section in FIG. 9, the inverted prism pattern is not limited thereto, and may have any cross-sectional shape. For example, the inverted prism pattern may have a polygonal cross-section (e.g., an n-polygonal cross-section, where n is an integer from 3 to 10), including a triangular cross-section. In addition, although not shown in FIG. 9, a light diffusion layer may further be formed on one surface of the light collecting sheet formed with the inverted prisms. The light diffusion layer may be formed as at least one of a coating layer including a pattern such as a convex/concave pattern and a coating layer containing diffusive particles.

Although not shown in FIG. 8, at least one protective sheet, a diffusive sheet, and/or the like may be further formed on the light collecting sheet 304 formed with the inverted prisms. In addition, although not shown in FIG. 8, a polarizing plate may be placed directly on the light collecting sheet 304 formed with the inverted prisms. The polarizing plate may include a polarizer and a protective film or a retardation film formed on at least one surface of the polarizer.

Hereinafter, a liquid crystal display according to embodiments of the invention is described with reference to FIG. 10. FIG. 10 is a cross-sectional view of a liquid crystal display according to embodiments of the present invention.

Referring to FIG. 10, a liquid crystal display 500 according to embodiments of the invention may include a liquid crystal display panel 501, polarizing plates 502 respectively formed on upper and lower surfaces of the liquid crystal display panel 501, and a backlight unit 503 formed below the liquid crystal display panel 501. The backlight unit 503 may include the backlight unit according to embodiments of the present invention.

The liquid crystal display panel 501 may include a liquid crystal panel including a liquid crystal cell layer encapsulated between a first substrate and a second substrate. The liquid crystal cell layer may include a vertical alignment (VA) mode, an in place switching (IPS) mode, a fringe field switching (FFS) mode, or a twisted nematic (TN) mode.

The polarizing plate 502 may include a polarizer and a protective film and/or a retardation film formed on the polarizer. Although the same polarizing plates are formed on the upper and lower surfaces of the liquid crystal display panel, respectively, in FIG. 10, different polarizing plates including different polarizers, protective films, and retardation films may be formed on the upper and lower surfaces of the liquid crystal display panel, respectively.

Next, embodiments of the present invention will be described with reference to some examples. However, it is understood that these examples are provided for illustration only and are not to be construed in any way as limiting the present invention.

### Example 1

A UV curable resin (refractive index: 1.60, PZPC-5503, Shina T&C Co., Ltd.) was coated onto an engraving roll formed with an engraved lenticular lens pattern, and one surface of a polycarbonate resin film (refractive index: 1.59, thickness: 500 μm) was brought into contact with the engraving roll, followed by UV irradiation at a fluence of 200 mJ, thereby forming a lenticular lens pattern having the specifications listed in Table 1 on the one surface of the polycarbonate resin film. Then, a UV curable resin (refractive index: 1.60, PZPC-5503, Shina T&C Co., Ltd.) was coated onto an engraving roll formed with an engraved prism pattern, and the other surface of the polycarbonate resin film was brought into contact with the engraving roll such that the longitudinal direction of the lenticular lens pattern laid at a right angle to the longitudinal direction of the engraved prism pattern, followed by UV irradiation at a fluence of 200 mJ to form a prism pattern having the specifications listed in Table 1 on the other surface of the polycarbonate resin film, thereby fabricating a light guide plate in which a first coating layer including the lenticular lens pattern was formed on one surface of the polycarbonate resin film, and a second coating layer including the prism pattern was formed on the other surface of the polycarbonate resin film.

### Examples 2 to 15

Light guide plates were fabricated as in Example 1 except that the specifications of the lenticular-lens pattern and the prism pattern were changed, as indicated in Table 1.

### Example 16

A UV curable resin (refractive index: 1.60, PZPC-5503, Shina T&C Co., Ltd.) was coated onto an engraving roll formed with an engraved lenticular lens pattern, and one surface of a polycarbonate resin film (refractive index: 1.59, thickness: 500 μm) was brought into contact with the engraving roll, followed by UV irradiation at a fluence of 200 mJ, thereby forming a lenticular lens pattern having the specifications listed in Table 2 on the one surface of the polycarbonate resin film. Then, a UV curable resin (refractive index: 1.60, PZPC-5503, Shina T&C Co., Ltd.) was coated onto an engraving roll formed with an engraved micro-lens pattern, and the other surface of the polycarbonate resin film was brought into contact with the engraving roll, followed by UV irradiation at a fluence of 200 mJ to form a micro-lens pattern having the specifications listed in Table 2 on the other surface of the polycarbonate resin film, thereby fabricating a light guide plate wherein a first coating layer including the lenticular lens pattern was formed on one surface of the polycarbonate resin film, and a second coating layer including the micro-lens pattern was formed on the other surface of the polycarbonate resin film.

### Examples 17 to 24

Light guide plates were fabricated as in Example 16 except that the specifications of the lenticular lens pattern and the micro-lens pattern were changed as indicated in Table 2.

### Example 25

A UV curable resin (refractive index: 1.60, PZPC-5503, Shina T&C Co., Ltd.) was coated onto an engraving roll formed with an engraved prism pattern having a curved surface at a top portion thereof, and one surface of a polycarbonate resin film (refractive index: 1.59, thickness: 500 μm) was brought into contact with the engraving roll, followed by UV irradiation at a fluence of 200 mJ, thereby forming a prism pattern with a curved surface at a top portion thereof and having the specifications listed in Table 3 on the one surface of the polycarbonate resin film. Then, a UV curable resin (refractive index: 1.60, PZPC-5503, Shina T&C Co., Ltd.) was coated onto an engraving roll formed with an engraved micro-lens pattern, and the other surface of the polycarbonate resin film was brought into contact with the engraving roll, followed by UV irradiation at a fluence of 200 mJ to form a micro-lens pattern having the specifications listed in Table 3 on the other surface of the polycarbonate resin film, thereby fabricating a light guide plate wherein the prism pattern having the curved surface at the top portion thereof was formed on one surface of the polycarbonate resin film, and the micro-lens pattern was formed on the other surface of the polycarbonate resin film.

### Examples 26 to 27

Light guide plates were fabricated as in Example 25 except that the specifications of the prism pattern having the curved surface at the top portion thereof and the micro-lens pattern were changed as indicated in Table 3.

### Example 28

A UV curable resin (refractive index: 1.60, PZPC-5503, Shina T&C Co., Ltd.) was coated onto an engraving roll formed with an engraved prism pattern having a curved surface at a top portion thereof, and one surface of a polycarbonate resin film (refractive index: 1.59, thickness: 500 μm) was brought into contact with the engraving roll, followed by UV irradiation at a fluence of 200 mJ, thereby forming a prism pattern with a curved surface at a top portion thereof and having the specifications listed in Table 3 on the one surface of the polycarbonate resin film. Then, a UV curable resin (refractive index: 1.60, PZPC-5503, Shina T&C Co., Ltd.) was coated onto an engraving roll formed with an engraved micro-lens pattern, and the other surface of the polycarbonate resin film was brought into contact with the engraving roll, followed by UV irradiation at a fluence of 200 mJ to form a micro-lens pattern having the specifications listed in Table 3 on the other surface of the polycarbonate resin film. Here, the micro-lens patterns were arranged such that the distance between the patterns was decreased and the density of the patterns was increased from one side of the polycarbonate resin film to the other side of the polycarbonate resin film. As a result, a light guide plate in which the prism pattern having the curved surface at the top portion thereof was formed on one surface of the polycarbonate resin film, and the micro-lens pattern was formed on the other surface of the polycarbonate resin film was fabricated.

### Example 29

A light guide plate was fabricated as in Example 28 except that the specifications of the prism pattern having the curved surface at the top portion thereof and the micro-lens pattern were changed as indicated in Table 3.

### Comparative Example 1

A UV curable resin (refractive index: 1.60, PZPC-5503, Shina T&C Co., Ltd.) was coated onto an engraving roll formed with an engraved prism pattern, and one surface of a polycarbonate resin film (refractive index: 1.59, thickness: 500 μm) was brought into contact with the engraving roll, followed by UV irradiation at a fluence of 200 mJ, thereby fabricating a light guide plate wherein a prism pattern having the specifications listed in Table 1 was formed on the one surface of the polycarbonate resin film, and no pattern was formed on the other surface of the polycarbonate resin film.

### Comparative Examples 2 to 6

Light guide plates formed with lenticular lens patterns and prism patterns having the specifications listed in Table 1 were fabricated as in Example 1.

### Comparative Example 7

A UV curable resin (refractive index: 1.60, PZPC-5503, Shina T&C Co., Ltd.) was coated onto an engraving roll formed with an engraved micro-lens pattern, and one surface of a polycarbonate resin film (refractive index: 1.59, thickness: 500 μm) was brought into contact with the engraving roll, followed by UV irradiation at a fluence of 200 mJ, thereby fabricating a light guide plate wherein a micro-lens pattern having the specifications listed in Table 2 was formed on the one surface of the polycarbonate resin film, and no pattern was formed on the other surface of the polycarbonate resin film.

### Comparative Examples 8 to 9

Light guide plates formed with lenticular lens patterns and micro-lens patterns having the specifications listed in Table 2 were fabricated as in Example 16.

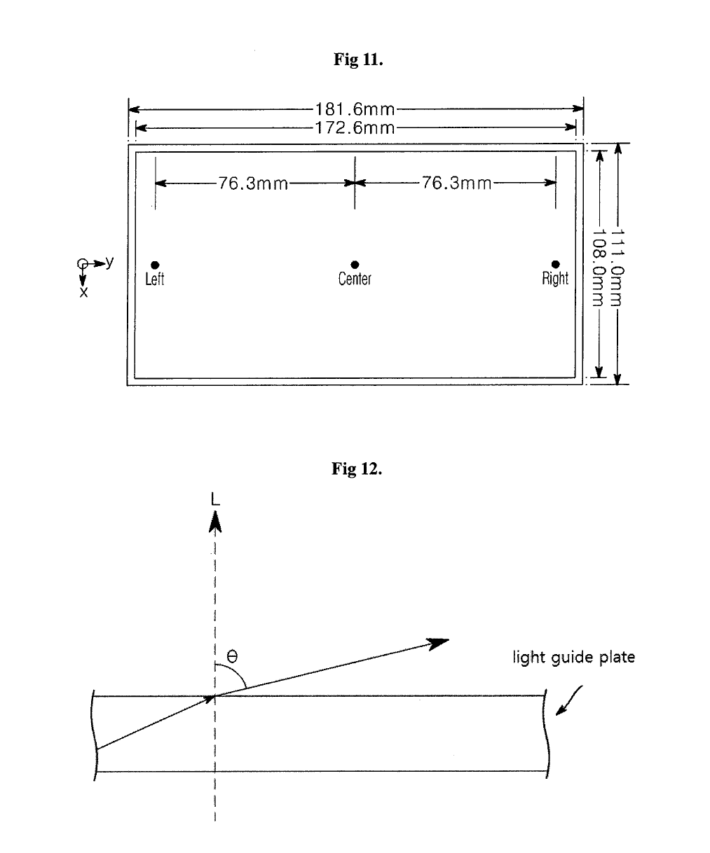

Each of the light guide plates fabricated in the Examples and Comparative Examples was cut to size (i.e., length×width: 181.6 mm×111.0 mm) as shown in FIG. 11, and a light collecting sheet formed with inverted prisms was placed on the light guide plate and inserted into a liquid crystal display, followed by measuring relative brightness and optical uniformity. The light collecting sheet formed with the inverted prisms was a light collecting sheet including an inverted prism pattern formed on a lower surface of a 125 μm thick polyethylene terephthalate film. The inverted prism pattern was formed of a UV curable resin (refractive index: 1.55) and had a width of 17 μm, a height of 12.6 μm, and a triangular cross-section with an apex angle of 68°. Relative brightness and optical uniformity were measured as follows.

(1) Relative brightness (%): In a backlight unit including a 1-side edge type LED light source, the light guide plate and a diffusive sheet formed with inverted prisms were sequentially stacked, followed by measuring brightness using a brightness tester (BM7, Topcon Co., Ltd.). Based on the brightness of Example 1 or 20 as brightness controls, relative brightness was calculated by the Equation: (Brightness(G2) of Examples and Comparative Examples/Brightness(G1) of Example 1 or 20)×100

(2) Light-exiting uniformity (%): A specimen was obtained as described above in the measurement of relative brightness, followed by measuring brightness at 17 points located at intervals of 10 mm along a centerline of the light travel direction (y-axis), thereby finding maximum and minimum values of brightness. Light-exiting uniformity was calculated by the Equation: (Maximum value of brightness/Minimum value of brightness)×100(%)

TABLE 1

| | Lenticular lens pattern | | | | Prism pattern | | | | | Light- |
|---|---|---|---|---|---|---|---|---|---|---|
| | | | | Radius | | | Apex | | Rel. | exiting |
| | Width | Height | Aspect | of curvature | Width | Height | angle | Aspect | brightness | uniformity |
| | (μm) | (μm) | ratio | (μm) | (μm) | (μm) | (°) | ratio | (%) | (%) |
| Example 1 | 45 | 14.1 | 0.313 | 25 | 150 | 4.6 | 173 | 0.031 | 100 | 64 |
| Example 2 | 45 | 14.1 | 0.313 | 25 | 150 | 3.9 | 174 | 0.026 | 111 | 69 |
| Example 3 | 45 | 14.1 | 0.313 | 25 | 150 | 3.3 | 175 | 0.022 | 111 | 73 |
| Example 4 | 45 | 14.1 | 0.313 | 25 | 150 | 2.6 | 176 | 0.017 | 110 | 71 |
| Example 5 | 45 | 14.1 | 0.313 | 25 | 150 | 2.0 | 177 | 0.013 | 107 | 66 |
| Example 6 | 45 | 14.1 | 0.313 | 25 | 130 | 2.8 | 175 | 0.022 | 114 | 74 |
| Example 7 | 45 | 14.1 | 0.313 | 25 | 110 | 2.4 | 175 | 0.022 | 117 | 74 |
| Example 8 | 45 | 14.1 | 0.313 | 25 | 100 | 2.2 | 175 | 0.022 | 118 | 75 |
| Example 9 | 45 | 14.1 | 0.313 | 25 | 90 | 2.0 | 175 | 0.022 | 116 | 73 |
| Example | 45 | 14.1 | 0.313 | 25 | 70 | 1.5 | 175 | 0.021 | 116 | 74 |
| 10 | | | | | | | | | | |
| Example | 45 | 14.1 | 0.313 | 25 | 50 | 1.1 | 175 | 0.022 | 114 | 74 |
| 11 | | | | | | | | | | |
| Example | 30 | 5.0 | 0.167 | 25 | 150 | 3.3 | 175 | 0.022 | 103 | 67 |
| 12 | | | | | | | | | | |
| Example | 40 | 10.0 | 0.250 | 25 | 150 | 3.3 | 175 | 0.022 | 112 | 66 |
| 13 | | | | | | | | | | |
| Example | 50 | 25.0 | 0.500 | 25 | 150 | 3.3 | 175 | 0.022 | 117 | 71 |
| 14 | | | | | | | | | | |
| Example | 20 | 2.1 | 0.105 | 25 | 150 | 3.3 | 175 | 0.022 | 102 | 73 |
| 15 | | | | | | | | | | |
| Comp. | — | — | — | — | 150 | 3.3 | 175 | 0.022 | 86 | 70 |
| Example 1 | | | | | | | | | | |
| Comp. | 10 | 0.5 | 0.05 | 25 | 150 | 3.3 | 175 | 0.022 | 91 | 69 |
| Example 2 | | | | | | | | | | |
| Comp. | 45 | 14.1 | 0.313 | 25 | 150 | 1.3 | 178 | 0.008 | 86 | 72 |
| Example 3 | | | | | | | | | | |
| Comp. | 45 | 27 | 0.600 | 25 | 150 | 4.6 | 173 | 0.031 | 93 | 71 |
| Example 4 | | | | | | | | | | |
| Comp. | 9 | 2.8 | 0.311 | 5 | 150 | 4.6 | 173 | 0.031 | 82 | 62 |
| Example 5 | | | | | | | | | | |
| Comp. | 90 | 28.2 | 0.313 | 40 | 150 | 4.6 | 173 | 0.031 | 91 | 73 |
| Example 6 | | | | | | | | | | |

TABLE 2

| | Lenticular lens pattern | | | | Micro-lens pattern | | | | Light- |
|---|---|---|---|---|---|---|---|---|---|
| | | | | Radius | | | | Relative | exiting |
| | Width | Height | Aspect | of curvature | Width | Height | | brightness | uniformity |
| | (μm) | (μm) | ratio | (μm) | (μm) | (μm) | Aspect ratio | (%) | (%) |
| Ex. 16 | 45 | 14.1 | 0.313 | 25 | 50 | 1.0 | 0.02 | 124 | 72 |
| Ex. 17 | 45 | 14.1 | 0.313 | 25 | 50 | 1.5 | 0.03 | 117 | 76 |
| Ex. 18 | 45 | 14.1 | 0.313 | 25 | 50 | 2.0 | 0.04 | 114 | 74 |
| Ex. 19 | 45 | 14.1 | 0.313 | 25 | 50 | 2.5 | 0.05 | 104 | 74 |
| Ex. 20 | 45 | 14.1 | 0.313 | 25 | 50 | 3.0 | 0.06 | 100 | 76 |
| Ex. 21 | 30 | 5.0 | 0.167 | 25 | 50 | 2.0 | 0.04 | 108 | 75 |
| Ex. 22 | 40 | 10.0 | 0.25 | 25 | 50 | 2.0 | 0.04 | 113 | 73 |
| Ex. 23 | 50 | 25.0 | 0.50 | 25 | 50 | 2.0 | 0.04 | 111 | 74 |
| Ex. 24 | 20 | 2.1 | 0.105 | 25 | 50 | 2.0 | 0.04 | 107 | 73 |
| Comp. | — | — | — | — | 50 | 2.0 | 0.04 | 72 | 69 |
| Ex. 7 | | | | | | | | | |
| Comp. | 45 | 14.1 | 0.313 | 25 | 50 | 4.0 | 0.08 | 92 | 71 |
| Ex. 8 | | | | | | | | | |
| Comp. | 90 | 28.2 | 0.313 | 50 | 50 | 3.0 | 0.06 | 92 | 68 |
| Ex. 9 | | | | | | | | | |

TABLE 3

| | Prism pattern having curved | | | | | | | | |
|---|---|---|---|---|---|---|---|---|---|
| | surface at top portion thereof | | | | | | | | Light- |
| | | | | Radius | Micro-lens pattern | | | Rel. | exiting |
| | Width | Height | Aspect | of curvature | Width | Height | Aspect | brightness | uniformity |
| | (μm) | (μm) | ratio | (μm) | (μm) | (μm) | ratio | (%) | (%) |
| Ex. 25 | 45 | 14.1 | 0.313 | 25 | 50 | 1.0 | 0.02 | 131 | 87 |
| Ex. 26 | 45 | 14.1 | 0.313 | 25 | 50 | 1.5 | 0.03 | 124 | 86 |
| Ex. 27 | 45 | 14.1 | 0.313 | 25 | 50 | 2.0 | 0.04 | 122 | 88 |
| Ex. 28 | 45 | 14.1 | 0.313 | 25 | 50 | 2.5 | 0.05 | 113 | 85 |
| Ex. 29 | 45 | 14.1 | 0.313 | 25 | 50 | 3.0 | 0.06 | 109 | 83 |

As shown in Tables 1 to 3, the light guide plates according to embodiments of the present invention provided high relative brightness and high light-exiting uniformity when the diffusive sheet formed with inverted prisms was placed thereon.

On the contrary, Comparative Examples 1 and 7 in which only the prism pattern or the micro-lens pattern was formed on the lower surface of the light guide plate had deteriorated brightness.

In addition, Comparative Examples 2 to 6 and 8 to 9 (which included the lenticular-lens pattern and the prism pattern or the micro-lens array pattern were formed on the upper and lower surfaces of the light guide plate, respectively, but had a radius of curvature and/or aspect ratio of the patterns outside the ranges according to embodiments of the present invention) had reduced brightness or light-exiting uniformity.

Therefore, the light guide plates according to embodiments of the present invention allow control of the light-exiting angle, and thus can prevent (or reduce) light scattering and exhibit good light collection efficiency, thereby providing improved brightness, even when a light collecting sheet including an inverted prism is used. In addition, embodiments of the present invention provide a light guide plate which provides high light-exiting uniformity regardless of the relative position of the light guide plate with respect to the light source, even when a light collecting sheet including inverted prisms is used. Furthermore, embodiments of the present invention provide a light guide plate which has good appearance and provides a narrow viewing angle, thereby improving brightness, even when a light collecting sheet including inverted prisms is used.

While certain exemplary embodiments of the present invention have been illustrated and described, those of ordinary skill in the art would appreciate that various modifications, changes, alterations, and equivalent embodiments can be made without departing from the spirit and scope of the invention, as defined in the attached claims.

What is claimed is:

1. A light guide plate comprising:
a base layer;
a first coating layer on a first surface of the base layer and comprising a first optical pattern having a curved surface at a top portion thereof; and
a second coating layer on a second surface of the base layer and comprising a second optical pattern,
wherein the first optical pattern has an aspect ratio of about 0.10 to about 0.50 and a radius of curvature of the curved surface of about 10 μm to about 35 μm, and
the second optical pattern has an aspect ratio of about 0.01 to about 0.07.

2. The light guide plate according to claim 1, wherein the first optical pattern comprises at least one of a lenticular lens pattern, a prism pattern having a curved surface at a top portion thereof, a micro-lens pattern, or an embossed pattern.

3. The light guide plate according to claim 1, wherein the second optical pattern comprises at least one of a prism pattern, a micro-lens pattern, an embossed pattern, or a lenticular lens pattern.

4. The light guide plate according to claim 1, wherein the base layer has a refractive index of about 1.50 to about 1.60.

5. The light guide plate according to claim 1, wherein each of the first coating layer and the second coating layer has a refractive index of about 1.50 to about 1.65.

6. The light guide plate according to claim 1, wherein the second optical pattern comprises a micro-lens pattern.

7. The light guide plate according to claim 1, wherein a ratio of the aspect ratio of the first optical pattern to the aspect ratio of the second optical pattern is about 2 to about 50.

8. The light guide plate according to claim 1, wherein the first optical pattern comprises a lenticular lens pattern and the second optical pattern comprises a prism pattern.

9. The light guide plate according to claim 1, wherein the first optical pattern comprises a prism pattern having a curved surface at a top portion thereof and the second optical pattern comprises a micro-lens pattern.

10. The light guide plate according to claim 1, wherein the first optical pattern comprises a prism pattern having a curved surface at a top portion thereof, and the second optical pattern comprises a micro-lens pattern, and wherein a distance between adjacent micro-lens patterns in the micro-lens pattern decreases and a density of the micro-lens patterns increases as a distance between the micro-lens patterns and a light source increases.

11. The light guide plate according to claim 1, wherein each of the first coating layer and the second coating layer has a refractive index greater than or equal to a refractive index of the base layer.

12. A method for fabricating a light guide plate, comprising:
forming a first coating layer comprising a first optical pattern on a first surface of a base layer; and
forming a second coating layer comprising a second optical pattern on a second surface of the base layer,
wherein the first optical pattern has at least one curved surface at a top portion thereof and has an aspect ratio of about 0.10 to about 0.50 and a radius of curvature of the curved surface of about 10 μm to about 35 μm, and
the second optical pattern has an aspect ratio of about 0.01 to about 0.07.

13. The method according to claim 12, wherein each of the first coating layer and the second coating layer has a refractive index greater than or equal to a refractive index of the base layer.

14. A backlight unit comprising:
a light guide plate; and
a light collecting sheet on the light guide plate and having an inverted prism,
wherein the light guide plate comprises the light guide plate according to claim 1.

15. The backlight unit according to claim 14, further comprising:
a polarizing plate directly on the light collecting sheet.

16. A liquid crystal display comprising the backlight unit according to claim 15.
